(19) United States
(12) Patent Application Publication
(10) Pub. No.: US 2014/0008991 A1
(43) Pub. Date: Jan. 9, 2014

(54) AUTHENTICATION AND CONTROL FOR INDUCTIVE POWER TRANSFER SYSTEMS

(71) Applicants: Charles Darrell Maud, Auckland (NZ); Steven Douglas Tetlow, Wellington (NZ)

(72) Inventors: Charles Darrell Maud, Auckland (NZ); Steven Douglas Tetlow, Wellington (NZ)

(73) Assignee: INNOVATION LIMITED, North Shore City (NZ)

(21) Appl. No.: 13/821,370

(22) PCT Filed: Sep. 6, 2011
(86) PCT No.: PCT/NZ2011/000182

§ 371 Date: Sep. 23, 2013

(30) Foreign Application Priority Data
Sep. 6, 2010 (NZ) 587804
Aug. 10, 2011 (NZ) 594517

(51) Int. Cl. H04B 5/00

(52) U.S. Cl. CPC H04B 5/0037
USPC 307/104

(57) ABSTRACT

An intelligent node (51) is provided for an inductive power transfer system which allows communication between a system power supply (1) and pick-up (3) and facilitates authentication of system components. The node (51) can also control operation of a pick-up (3).

### FIELD OF THE INVENTION

This invention relates to authentication and control methods and apparatus for inductive power transfer (IPT) system apparatus. The invention also relates to communication between IPT system apparatus components.

### BACKGROUND

IPT systems typically comprise a primary conductive path (sometimes referred to as a track) which is energised by an appropriate electrical power supply such that a current is provided in the primary conductive path. The primary path will typically be an elongate cable which is energised with radio frequency (RF) current by a power supply. Distributed along the primary conductive path, but not in electrical contact with the path, are one or more pick-up devices which each have a secondary pick-up coil in which a current is induced by virtue of mutual inductance between the pick-up coil and the primary conductive path. Each pick-up usually includes control apparatus which controls the flow of power from the primary conductive path to the pick-up device so that the pick-up device may supply a load. IPT systems and an appropriate control implementation are disclosed generally in U.S. Pat. No. 5,293,308 to Boys. Furthermore, U.S. Pat. No. 6,459,218 discloses an application of IPT systems in powering road studs.

It is desirable to enable pick-ups to be controlled in various ways. In the road stud example, it is desirable to control the manner in which road studs are individually energised to enable traffic flow control. Therefore, in one example, road studs in a string may be controlled to be sequentially energised at a rate which can indicate to drivers a required speed of traffic flow.

In order to control the pick-ups so that the loads are operated in the desired fashion some form of communication is desirable between apparatus remote from the pick-up device, and the pick-up device itself. In one proposed communication system which is set out in published PCT patent specification WO 2005/031944, the primary conductive path is used as a communication path for instructions to be addressed to individual pick-up units by frequency modulating the current in the primary conductive path.

In another system described in WO 2006/137747, a return communication function is provided in which a pick-up unit responds to an instruction by supplying power to a load. This affects the current in the primary path. The change in current is detected and used to determine the response from the pick-up.

In road stud applications, the performance of the system is crucial to ensuring safety. This is because road stud systems are often used to guide vehicular traffic, and in some situations road stud systems can provide directional guidance during emergencies. Therefore, for example road stud systems using IPT are often installed in vehicular tunnels, and can provide guidance to a user, for example by indicating the direction of travel, for the user to exit the tunnel. Roadway IPT systems typically comprise a primary conductive path which is buried within the roadway. A number of road studs (often numbering many hundreds) is provided on top of the road surface. Therefore, in use, road studs that malfunction are simply replaced as part of a regular maintenance program. However, there is a risk that the replacement road stud unit is not specified to function with the primary path that is being laid in the roadway. Furthermore, conductive “nodes” are frequently used either between the primary conductive path and a road stud, or are directly connected into the primary conductive path in order to provide a region of a concentrated magnetic flux for interception by the road stud. An example of a node is disclosed in U.S. Pat. No. 7,675,197 the contents of which are incorporated herein by reference. Furthermore, nodes may also be replaced in a system installation over time. These represent an additional safety issue.

### OBJECT OF THE INVENTION

It is an object of the present invention to provide an authentication and/or communication method, system or apparatus for use in IPT systems which will at least overcome one or more disadvantages with existing systems, or will at least provide the public or the industry with a useful alternative.

### SUMMARY OF THE INVENTION

Accordingly in one aspect the invention provides an inductive power transfer system (IPT) node comprising a communication circuit for receiving a communication signal from another component of an IPT system.

Preferably the communication circuit can transmit the communication signal by inductive coupling to a further component of an IPT system.

Preferably the communication circuit can transmit a return communication signal to the IPT system component.

Preferably a control circuit is provided whereby the node controls power received from the IPT system in response to the communication signal.

Preferably the node controls the power supplied to an IPT pick-up in response to the communication signal.

Preferably the node transmits control signals to an IPT pick-up to thereby control the pick-up dependent on the communication signal.

In another aspect the invention provides an inductive power transfer (IPT) system including a primary conductive path, a plurality of nodes coupled to the primary conductive path, and at least one pick-up device coupled to each node and capable of receiving power inductively from the respective node, and wherein at least one node includes a communication circuit for receiving or transmitting a communication signal to or from the primary conductive path and/or the pick-up device.

Preferably the communication signal comprises an authentication signal.

Preferably the communication signal comprises a control signal.

In another aspect the invention provides an authentication method for an IPT system, the method including the steps of establishing communication between one component of the system and one or more other components of the system whereby the one or more components detects an authentication identifier of the one or more other components.

Preferably the method includes the step of firstly transmitting an authentication request.

Preferably the method includes processing the authentication identifier to determine whether the identifier is valid.

Preferably the authentication identifier comprises a code, such as a binary number or sequence for example.

Preferably the method includes a step of determining whether or not the first component is adapted to operate with the further component.

Preferably the method includes a step of comparing the authentication identified with a table of stored identifiers.

Preferably the method further comprises the step of the first component ceasing to operate should the authentication identifier not match one or more of the identifiers in the list.

In a further aspect of the invention broadly consists in an IPT system node having a communication means adapted to receive an authentication identifier from one or more of a pick up device and a primary power supply, and a processing means to compare the received authentication identifier with one or more stored identifiers.

In a further aspect the invention broadly consists in an IPT system node having: a resonant circuit including a coil tuned to resonate at a selected resonant frequency, and means to alter the selected resonant frequency of the resonant circuit.

Preferably the means to alter the selected resonant frequency includes one or more switching devices.

Preferably the means to alter the selected resonant frequency includes one or more reactive components which may be connected to, or disconnected from, the resonant circuit.

Preferably the node includes a sensing means to sense one or more properties of the node and/or one or more properties of the resonant circuit.

Preferably the node includes a communication means capable of receiving instruction.

Preferably the note includes a communication means capable of transmitting an instruction.

Preferably the selected resonant frequency may be varied dependent upon the instruction and/or dependent upon a property sensed by the sensing means. In one embodiment the node is physically connected to a power supply. In an alternate embodiment the node is inductively coupled to a power supply.

In a further aspect the invention broadly consists in an IPT system in which one or more nodes of the IPT system control the power available to one or more pick up devices which the one or more nodes supplies.

Preferably the one or more nodes may be used to control the one or more pick up devices.

Further aspects of the invention will become apparent from the following description.

The invention also broadly consists in any novel feature or combination of features (including equivalents of those features) disclosed herein.

### DRAWING DESCRIPTION

One or more embodiments of the present invention will be described by way of example with reference to the following accompanying drawings, in which

FIG. 1: is a block diagram of a known form of IPT system.

FIG. 2: is a block diagram of an IPT communication circuit adapted to receive and interpret communication signals.

FIG. 3: is a block diagram of an electric circuit for a pick-up, such as a road stud, of an IPT system that may communicate with the device of FIG. 2.

FIG. 4: is a schematic drawing of a road stud IPT system including a passive resonant node according to the prior art.

FIG. 5: is a schematic of a road stud IPT system such as that shown in FIG. 4 including a passive resonant node and an intelligent road stud which is capable of communicating with the primary power supply.

FIG. 6: is a schematic of a road stud system including an intelligent resonant node capable of communication with the road stud and the primary power supply.

FIG. 7: is a schematic diagram of a road stud IPT system as shown in FIG. 6 but using a passive road stud.

FIG. 8: is a plan view of an intelligent node.

FIG. 9: is a side elevation of the node of FIG. 8.

FIG. 10: is a block diagram of an alternative communication and IPT power receiving pick-up device such as a road stud.

FIG. 10A: is a circuit diagram of an embodiment of an intelligent node.

FIG. 11: a plan view or side elevation of a node according to one embodiment of the invention.

FIG. 12: is a perspective view of another embodiment of a node according to the invention.

FIG. 13: is a perspective view of the node construction shown in FIG. 12 but with the ferrite and coil encased in a protective covering or coating.

FIG. 14: is a perspective view of yet a further embodiment of a node according to the invention.

FIG. 15: is a perspective view of yet another embodiment of a node according to the invention.

FIG. 16: is a perspective view of the node of FIG. 15 but further including a pick-up magnetic structure including a coil.

FIG. 17: is a perspective view of a node according to FIG. 14 but further including a pick-up structure including a pick-up coil.

### DETAILED DESCRIPTION OF PREFERRED EMBODIMENTS

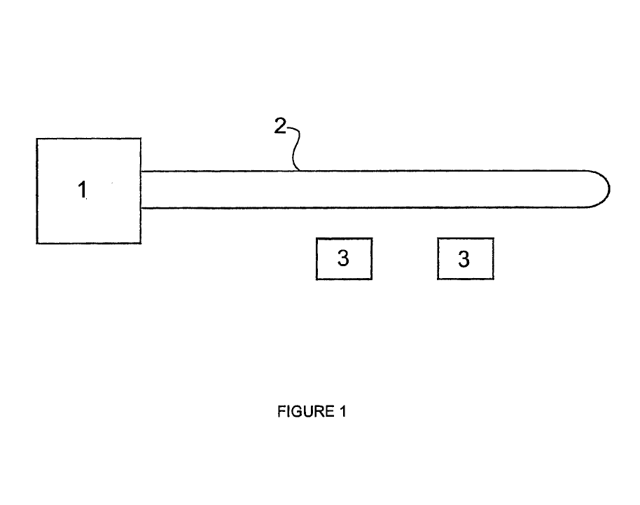

Referring to FIG. 1, a known IPT system is shown diagrammatically, comprising a power supply 1 which energises the primary conductive path 2. Placed adjacent to the path 2, but not in physical electrical contact with the path, are one or more pick-up devices 3 which may receive power from the primary conductive path by virtue of being inductively coupled to the path. Such systems are described in greater detail and in U.S. Pat. Nos. 5,293,308 and 6,459,218.

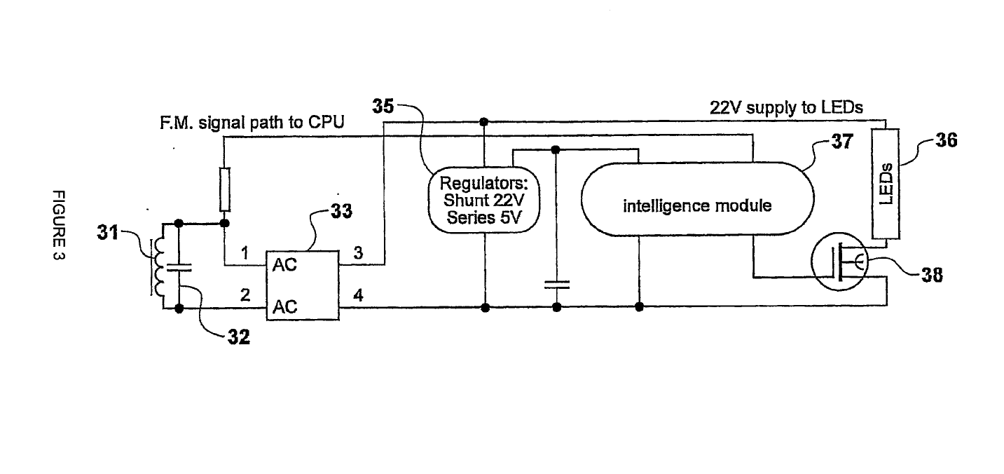

Referring now to FIG. 3, a block diagram for a possible pick-up 3 is illustrated. The pick-up has a pick-up coil 31 which is tuned by a tuning capacitor 32 to create a resonant circuit which is responsive to the magnetic field generated by the RF current in the primary conductive path 2.

A rectifier and control module 33 rectifies the alternating current from the resonant circuit formed by components 31 and 32. The output of unit 33 is regulated by regulators 35 to provide two power supplies. The first power supply (in this example 22V) is provided to a load 36 which, in this example, is a road stud in which the load comprises a number of light emitting diodes (LEDs) 36. Those skilled in the art will appreciate that in alternate embodiments other types of load may be supplied, and that the pick-up may supply higher power loads than those in the embodiments described herein.

A second power supply which, in this example, is a 5V supply provides the supply for an intelligence module 37 which is typically provided in the form of an integrated circuit, such as a microprocessor. Module 37 is provided directly with a signal feed from the resonant circuit formed by components 31 and 32, and has an output which is used to control a switching device 38 which is operable to energise the load 36.

In use, communication signals, for example frequency modulated signals, which are imposed on the current in the primary conductive path 2 are also received in the resonant circuit formed by components 31 and 32 of the pick-up, and are passed directly to module 37 where they may be interpreted as a particular instruction. For example, the instruction may be to activate the load so as to provide a physical signal to traffic.

In one embodiment of the invention, the instruction may be communicated using the system or method disclosed in the aforementioned publication WO 2005/031944 the disclosure of which is incorporated herein by reference.

The instruction may alternatively be one to energise the LEDs for only a limited period of time, or to enter into a sequence, for example, a flashing sequence. Those skilled in the art to which the invention relates will appreciate that the instruction may be more complex in nature, for example if the load comprises a motor, then the instruction may be to index the motor to a predetermined position, or cause a carriage that the motor drives to move to a predetermined location. The module 37 causes the load to be energised by activating switch device 38 as required.

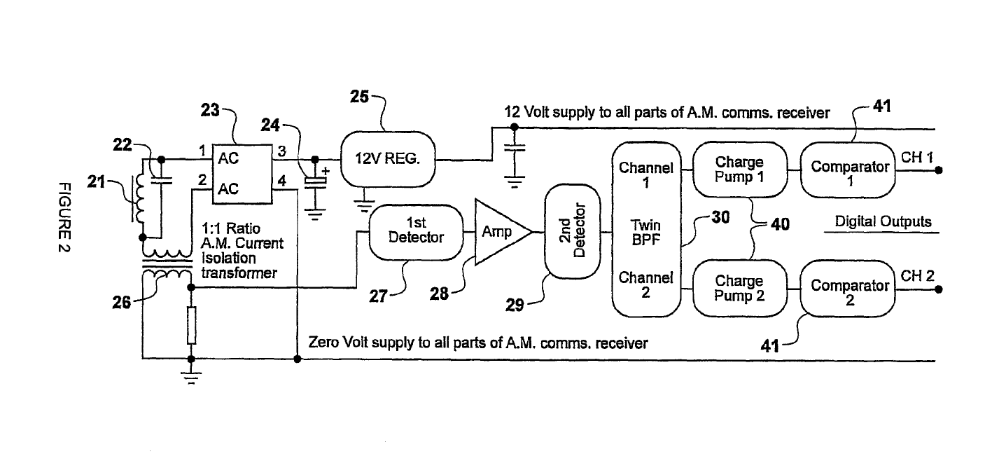

The act of energising the load causes power to be transferred from the primary conductive path to the resonant circuit of the pick-up, and this in turn causes a perturbation or variation in the current in the primary conductive path 2. This variation in the current in the primary conductive path will depend upon the manner in which the load is energised. In a preferred embodiment, the load is energised at a selected frequency. The variation in the primary path current can thus be detected as an amplitude or frequency component of the current in the path by an appropriate communication circuit which is in communication with the primary conductive path 2. An example of such an amplitude modulated communication circuit is shown in FIG. 2, and will be described further below. Although the circuit shown in FIG. 2 is intended to be provided adjacent to the power supply 1, those skilled in the art will appreciate that it could be located at any other convenient point along the primary conductive path and does not need to be in physical electrical contact with the primary conductive path.

The module 37 may energise the load in a variety of different ways to provide the return communication signal for detection by the circuit of FIG. 2. For example, the return communication signal may simply comprise detection that the load 36 has been energised after the instruction to energise the load has been received. However, as an alternative, the module 37 may energise the load in a predetermined pattern of operation to provide a return communication signal. For example, if the load comprises light emitting diodes, then these may be switched at a very fast rate so that the objective of providing illumination is still achieved, and may appear to the road user as constant illumination, but the very fast flashing of the LEDs creates a predetermined variation that can be provided as a digitally encoded signal (i.e. can be detected as a series of binary digits that may form a digital word) which is imposed on the primary conductive path for detection. In a preferred embodiment the load is activated at one or more predetermined frequencies, so that the variation comprises changes of frequency that may be demodulated to provide a digital output. Alternatively, a single frequency may be used which changes with time by being either present or absent to provide the changes for decoding. Those skilled in the art will appreciate that other modulation techniques could be used.

As another example, the pick-up 3 may be provided with various sensors which provide information to module 37. In one example, the sensor may be a temperature sensor which can provide an indication as to whether a fire may be present in the vicinity of the pick-up. In another example, the sensor may be a light sensor which can detect the presence or absence of ambient light, for example whether the lighting in a tunnel in which the pick-up may be located, is operative or inoperative. With each of these sensors, an instruction may be sent over the primary conductive path addressed to one or more particular pick-ups, requesting them to report back the status of the sensor or sensors. The module 37 can then take a reading from the sensor and energise the load 36 in a predetermined pattern that causes a variation in the current primary conductive path 2 which may be detected and decoded to reveal the reading provided by the relevant sensor.

Referring now to FIG. 2, a coil 21 and tuning capacitor 22 comprise a resonant circuit which picks up energy from the primary conductive path 2, and which is preferably located adjacent to the power supply 1 (refer to FIG. 1). A rectifying and control module 23 is filtered by a filter capacitor 24. A regulation circuit 25 provides a power supply (in this example a 12V supply) to the communications receiver apparatus. A current isolation transformer 26 provides an isolated signal representative of the current on the primary conductive path 2 to a first detector 27. The output of the detector 27 is provided to amplifier 28, the output of which is provided to a second detector unit 29 and then passed to a twin band pass filter (BPF) 30 which provides a two channel output from which information is provided in two channels. In practical terms, the twin BPF could be a single Band Pass Filter, or even a multiple band pass filter. In the embodiment illustrated, the twin Band Pass filter features a pair of fairly high ‘Q’, solid state, audio filters. These offer a small amount of analogue gain, at the frequency of operation, and have a response curve that is much like that of the tuned circuits used in the pickups. At frequencies that are outside of their pass band, they substantially attenuate the signal. These filters are tuned to match the frequencies that are emerging from the pick-ups 3 during return communications events. In a preferred embodiment Digital Signal Processing (DSP) devices may perform this role. Two BPF's allow the following concepts to be implemented:

1) The use of ‘frequency warble’ i.e. having two frequencies between which the detected signal moves on the return communications signal, to improve the rate at which the data could be returned to the power supply's receiver.

2) The use of two distinct frequencies, in order to allow two pick-ups to reply at the same time.

Aspect 2) is aimed at providing an ‘emergency channel’ in case an urgent communications event takes place during normal communications. This permits a greater degree of latitude, where communications collisions may otherwise occur.

The signal in each channel may be decoded by appropriate known decoding means to provide the required information. In the embodiment shown the charge pumps 40 that appear after the filters, are intended to develop a charge on a capacitor when the filter receives a signal of the correct frequency. That DC level is then fed to the appropriate comparator 41, in order to provide a logic ‘1’ or ‘0’ state.

From the comparator's output, the data that was imparted to the primary path by the pick-up under scrutiny is able to be recovered.

In a preferred embodiment, the communication occurs digitally, and a digital signal processing integrated circuit may be used to perform signal recovering control.

From the foregoing it will be seen that embodiments of the invention may provide significant advantages such as:
no additional communications apparatus is required within the remote communications device on the pick-up that is being monitored;
the receiver is totally isolated which allows one or more of them to be placed anywhere on the primary conductive path of the IPT system.

Although the variations in the current primary conductive path are very small, typically 0.1%, they are readily picked up by an inductively coupled receiving device. As the receiver and senders are inductively powered, they may be placed at any point along the length of the conductive path. In practice the receiver circuit (such as that shown in FIG. 2) is housed within the cabinet of the inductive power source, and the senders i.e. the pick-ups, numbering from 1 to 100's, are distributed along the length of the path.

In a preferred embodiment, the variations in the current of the primary path that are caused by the load variation are immediately converted into their digital representation and the response may be used to decide upon the condition of the pick-up device under scrutiny.

We have found that in a system containing 200 road studs (each road stud being a pick-up, or the load supplied by a pick-up), for example, on a 2000 m long path, the generator may need only a few minutes to check the entire system.

Furthermore, in the example of a road stud system, the stud that is under interrogation will appear to the motorist to become slightly less bright for about two seconds, then return to normal brightness. As each road stud pick-up already contains a small microprocessor that permits it to understand instructions from the generator, it is only a simple matter of adding software so that it can enter the return communications loop.

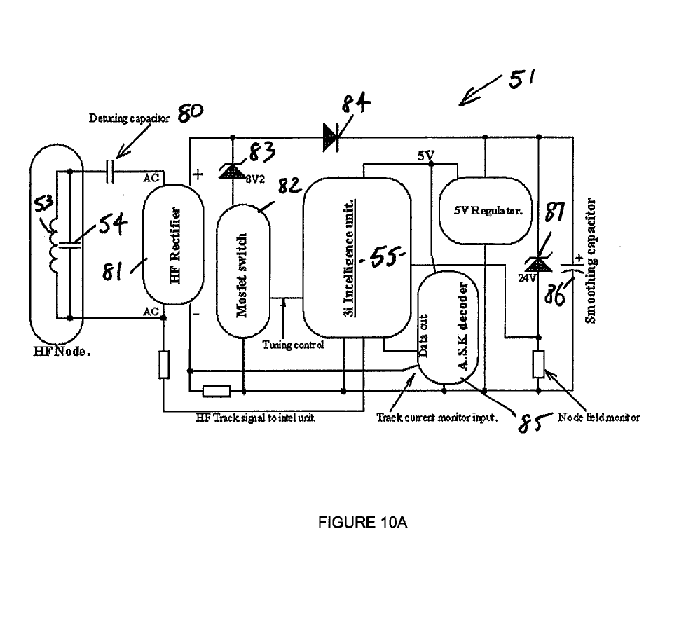

Referring to FIG. 10, another embodiment of a possible pick-up or receiving device 3 is illustrated. The pick-up shown in FIG. 10 uses like reference numerals to refer to like features of the FIG. 3 embodiment. The primary difference between the pick-up device shown in FIG. 10 and that shown in FIG. 3 is that the FIG. 10 embodiment has an additional switching arrangement 60 which is controlled by the intelligence unit or microprocessor 37. This switching arrangement 60 may comprise a single switch such as a MOSFET transistor for example, or could be a number of switches, such as a pair. The effect is that the switch arrangement 60 comprises an electric shunt which delivers a heavy load to the pick-up circuit and is therefore clearly seen on the track. Therefore, when the power receiving device 3 (for example a road stud) needs to create a return communication event, the control unit 37 rapidly switches switch arrangement 60 on and off at a carefully controlled rate of speed. This is set up in such a way that the LEDs 36 momentarily lose power, but the power supply to the intelligence unit 37 remains intact. One of the advantages of this is that the return communication signal is always loud and clear on the track, and is not degraded by variations in the overall working current of the track cable. Furthermore, the device has the ability to reply when the LED 36 is switched off. This overcomes disadvantages of arrangements which may lose signal strength as the track current is raised. This is due to brightness limiting circuits becoming more aggressive when track currents are high. If all the LEDs 36 were to fail, the pick-up circuit is still able to activate a load to produce a return communication signal on the track. Furthermore, in this embodiment the receiver device can still reply when it is distant from the track or if the track current is abnormally low.

It will be seen by placing the switching arrangement 60 before the regulating devices present in the pick-up circuit arrangement, it is insensitive to major variations in track current.

The discussion above describes a communication system which allows the pickup devices such as road studs to communicate with the primary power supply. Although this document refers to communication with the primary power supply, those skilled in the art will appreciate that the communication may occur with a communication device which is associated with the primary power supply, or which is otherwise in communication with the primary conductive path.

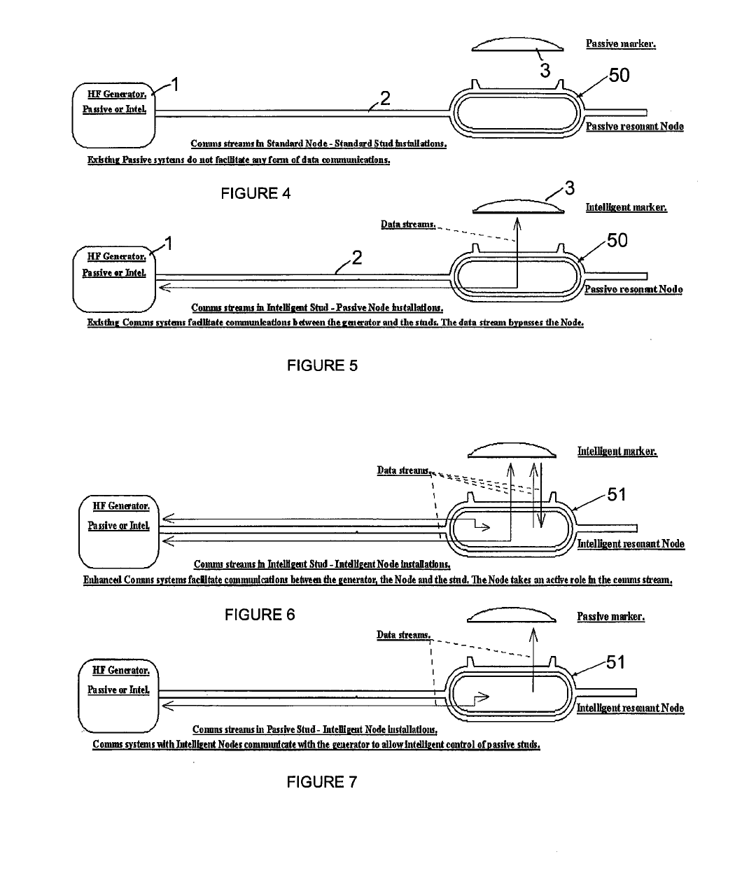

In order to ensure that an IPT system operates safely, it is important to ensure that the various components of the system are intended to work with each other. As described above, apart from the road stud device, the systems may also include a “node”. A node is typically a resonant component which is in sufficiently close proximity to a primary conductive path so as to intercept magnetic flux from that path and provide an area of enhanced field strength for interception by a pick-up device which requires power, such as a road stud. Therefore, a node is typically provided in a roadway between the primary conductive path which is buried within the roadway and the road stud which is provided on an upper surface of the roadway. In some embodiments, the node may be directly connected within the primary conductive path. Examples of node arrangements are shown in FIGS. 4 to 7, in which the nodes are generally referenced 50, and 51. Referring to those figures it can be seen that in the known construction of FIG. 4, the node is simply a resonant component which is located between the primary conductive path 2 and the road stud 3. FIG. 5 represents a system whereby the resonant node is simply a “conduit” for passing power and signals between an intelligent pickup or road stud device 3 and the power supply 1.

In FIG. 6, a new system is illustrated in which the node (referred to herein as an “intelligent node”) can communicate with the power supply 1 and with the road stud 3. Similarly in FIG. 7, an intelligent node 51 is shown which can pass a data stream to a passive or unintelligent road stud or pick up 3, and can also communicate with a power supply.

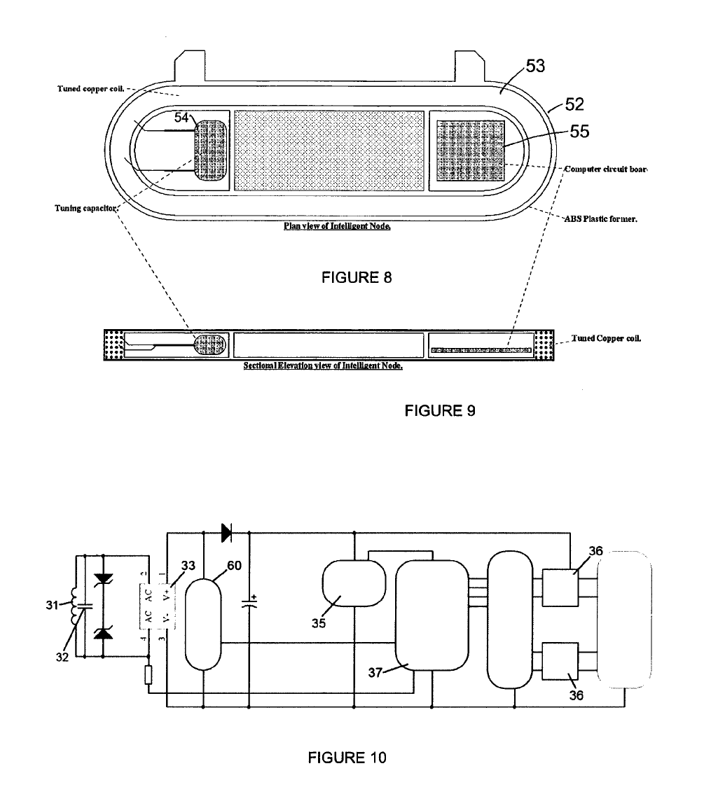

Turning now to FIG. 8, the construction of intelligent node 51 is shown in greater detail. As can be seen, a former 52, which may be constructed from a plastic material for example, is provided to provide a base about which or in which a coil 53 is provided. The coil 53 is tuned by a tuning capacitor 54 which provides a resonant circuit that is tuned to the resonant frequency of the current in the primary conductive path. A processing means such as a micro processor or other integrated circuit 55 is also provided. FIG. 9 shows the construction in sectional elevation.

The processor 55 has an input (not shown), or a sensor, which allows it to detect the current in the coil 53. Due to the close proximity between the coil 53 and the road stud pick-up coil 31, a communication protocol can be established by virtue of the inductive connection therebetween. Similarly, a communication connection can be established if required between the power supply 1 and the intelligent node 51. The integrated circuit 55 may include a look up table so that communications which are passed to or from the road stud and or the power supply can be monitored for detection of an authentication identifier provided by one or both of those components. The identifier can then be compared with one or more identifiers stored in memory such as a look up table. If the identifier is present, then the components with which the intelligent node co-operates are authenticated and the system operates as normal. However, if the authentification identifier is not transmitted to the node, or is not an identifier which is present in the memory of the node, then the node will not operate correctly. Those skilled in the art will appreciate that a processor such as integrated circuit 55 may also be provided in the road stud and/or in the power supply so that those units may also perform an authentication function. It will also be apparent that the intelligent node may actively request an authentication identifier from the other components or may simply function to receive that information on a periodic basis from the other components.

Therefore, the resulting instruction using an intelligent node such as node 51 is when such node is placed in an installation that has a power supply which is not programmed to co-operate with it, then the node will shut down shortly after power up. The same behaviour will occur when a non-authentic pickup device such as the road stud is placed upon or adjacent to the node. In one embodiment at power up, and regularly thereafter, the intelligent node 51 communicates with the power supply and with the pickup device. During these events, a request for product authenticity (i.e. an authentication identifier) is transmitted by the intelligent node 51. Should either of the other devices fail to respond as anticipated to the request, then the intelligent node 51 enters the shut down state. During this time, communications between the node and the power supply are still viable, so recovery can occur upon receipt of the required validating code.

In one embodiment, the processor 55 in node 51 may be operable to detune the resonant circuit formed by coil 53 and tuning capacitor 54. The resonant circuit in node 51 is tuned to have a natural resonant frequency which is the same, or substantially the same, as the RF excitation frequency present in the path 2 (as described above with reference to FIG. 1). Those skilled in the art will appreciate that the coil 53 may include sufficient inherent capacitance to be turned to an appropriate resonant frequency without a turning capacitor being required. Having the node tuned for resonance at the frequency of the current in the path 2 enables optimum coupling to occur and therefore maximum power transfer from the path 2 to the pickup device 3 in use. However in some situations a highly tuned node 51 can suffer problems. For example, if there is no, or very little, load on the pick-up device 3 then the node 51 can become overheated. Furthermore, in some situations it can be desirable to have minimal functionality in the pick-up 3 such that the cost of the pick up device is minimised (which may be a consideration in applications such as road stud devices in which a road stud can be damaged by traffic and have to be frequently replaced). Furthermore, in some applications due to component tolerances and component aging, the natural resonant frequency of the resonant circuit in node 51 may change over time, or simply not be optimally tuned at the time of manufacture. The power supply that provides the RF current in path 2 may also suffer a change in frequency over time. To accommodate these requirements, one embodiment the invention provides a node 51 which includes means to alter the selected resonant frequency of the resonant circuit. This may be achieved in a variety of different ways.

In one embodiment, the processor 55 alters the natural resonant frequency of the resonant circuit by switching in additional capacitance (which has the effect of increasing or decreasing the overall capacitance of the resonant circuit). In another embodiment a variable capacitance can effectively be provided by phase switching a capacitor in and out of the resonant circuit. Similarly, a variable inductor, or one or more additional discrete inductances, can also be provided. In yet another embodiment, a switch may be used to short out a tuning capacitance in the resonant circuit and thus effectively de-tune the resonant circuit. The processor 55 has one or more inputs which are used to sense properties or parameters of the node itself and/or the resonant circuit so that the resonant frequency of the resonant circuit can be selectively varied. Thus in one embodiment, a temperature sensor is provided, and upon detection that there is excess heat in the node 51, the processor acts to switch in or out one or more reactive components (i.e. inductances and/or capacitances) developments in the circuit to alter the resonant frequency away from the frequency of the current in path 2. This has the effect of detuning the node and therefore lowering the energy dissipation which is causing the heat build up.

In another embodiment, the processor 55 tunes or detunes the resonant circuit in the node 51 dependent upon information from a communication means. For example, a communication may comprise an instruction to tune the resonant circuit towards the resonant frequency of the current in path 2 to thereby make more power available to a pick-up device 3. The result of this action may be to activate a load supplied by the pick-up. For example, if the pick-up is a road stud, then tuning the node 51 can result in the road stud being illuminated, and detuning the node 51 can result in the illumination being extinguished. The instruction to tune or detune may occur from a remote controller, for example imposing a communication control signal on path 2, and/or may occur from a request from a pick-up device 3 in a similar fashion to the communications referred to in other embodiments above.

In another embodiment, the processor 55 uses information from detection of the current resonant circuit in coil 53 (and/or the voltage across tuning capacitor 54) to detect parameters of the resonant circuit, including the frequency of operation of the resonant circuit, and this information can be used to assist with tuning or detuning the resonant circuit toward or away from the frequency of the current in the path 2.

Referring to FIG. 10A, a circuit diagram of an embodiment of an intelligent node 51 is shown. As described above, the node 51 of FIG. 10A includes an intelligence module (which may be provided in the form of a processor) 55, and can function as an authentication device. The node 51 operates as a return communications receiver and transmitter, thereby allowing it to communicate with both the HF power source and the associated electrical load on a pick-up or power receiving device.

A parallel resonant circuit comprising coil 53 and tuning capacitor 54 forms the basis of the nodal device. It's configuration is the same as that of a passive node. Under normal conditions, detuning capacitor 80 passes a small amount of AC current to the HF rectifier 81, which in turn provides a DC feed for the intelligence module 55 and the Amplitude Shift Keying decoder 85.

DC smoothing, and overvoltage protection are provided by a capacitor 86 and a zener diode 87.

The A.S.K. decoder 85 allows the module 55 to monitor the track current in search of communication events coming from the inductive load that it is powering. At the same time, the track frequency is being fed into the module 55. This permits it to receive commands from the HF power source in the same way as the intelligent markers (such as the road studs dicussed above) do.

The Mosfet switch 82 is under the control of the microprocessor 55, thus allowing it to detune the node when required. It achieves this by creating a major load variation on the DC side of the rectifier 81. This causes the detuning capacitor 80 to appear in parallel with the HF node's existing tank circuit. The result is a marked reduction in the working frequency of the node. Once so detuned, the node loses its ability to couple energy to the load, thereby rendering it inoperative.

To prevent power failure within the Node's electrical system while detuned, a zener diode 83 is added to the Mosfet switch circuit. This prevents total collapse of the onboard 24V rail, by not letting it fall below approximately 7.5 volts. To prevent backflow of current from the smoothing capacitor 86, a blocking diode 84 is placed in the positive supply rail. While operating like this, all processing and monitoring functions are retained.

As the Authenticating Node alternates between tuned and detuned states, minor changes are imposed on the track current. These changes are of the same type as those that emerge from return communications illuminated markers discussed above, and are used in the same way for data transmission.

Given these attributes the node 51 is able to participate in two way communications with the HF power source, as well as it can with the inductive load that it is paired with. In the absence of a load, the node is able to shut down in order to avoid self heating, and to reduce power losses in the system. This is achieved by way of a ‘Node field monitor’ circuit. Under normal circumstances, the inductive load is sufficient to prevent the 24V zener diode 87 from conducting. When the load is absent, the node's electro-magnetic field rises sharply, elevating the onboard DC rail voltage to the point where the zener begins conducting. When this happens, a voltage is imposed across the zener's Cathode load resistor. This is detected by the microprocessor 55, which then initiates the detuning/polling process.

Accordingly, the node has at least three possible shutdown modes:

1) Shutdown/Startup under direct control of the HF power source,

2) Shutdown/Startup when the load is physically removed/reapplied,

3) Shutdown/Startup based on failure/success of authentication process.

During operational modes 2 and 3, automatic polling is able to take place. This is characterised as regular, but brief, bursts of full power operation. During these events, the inductive load has the opportunity to correctly identify itself. This will result in a series of brief flashes, occurring at a preset rate, from non compliant illuminated markers. Compliant marker devices will power up in the normal way upon completion of a single polling cycle.

In yet another embodiment, we have found the use of ferrite in the node 51 (and preferably also in the pick-up 3) can be advantageous in providing effective mutual coupling between the node and pick up. In one embodiment, a semi torodial shaped ferrite core is provided.

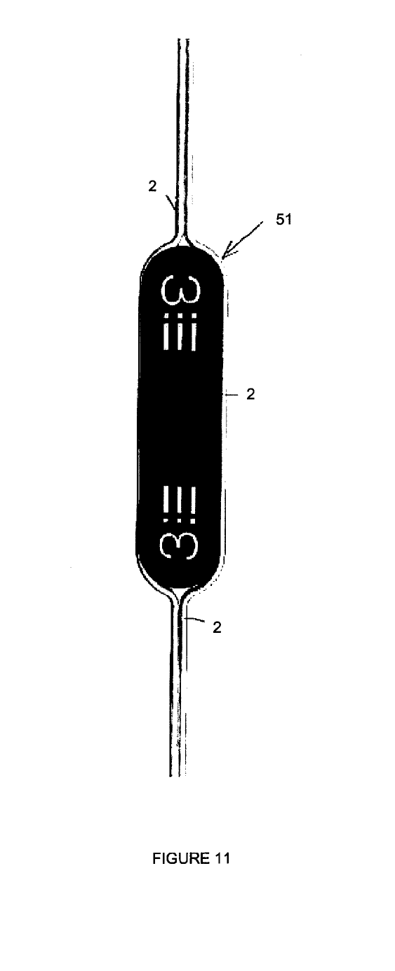

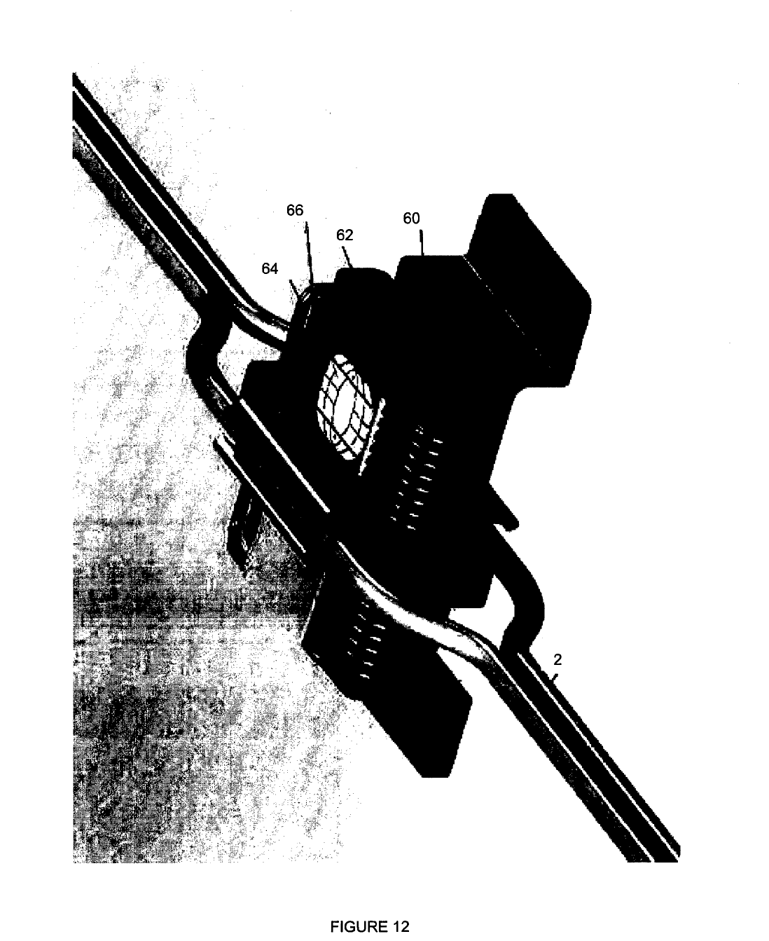

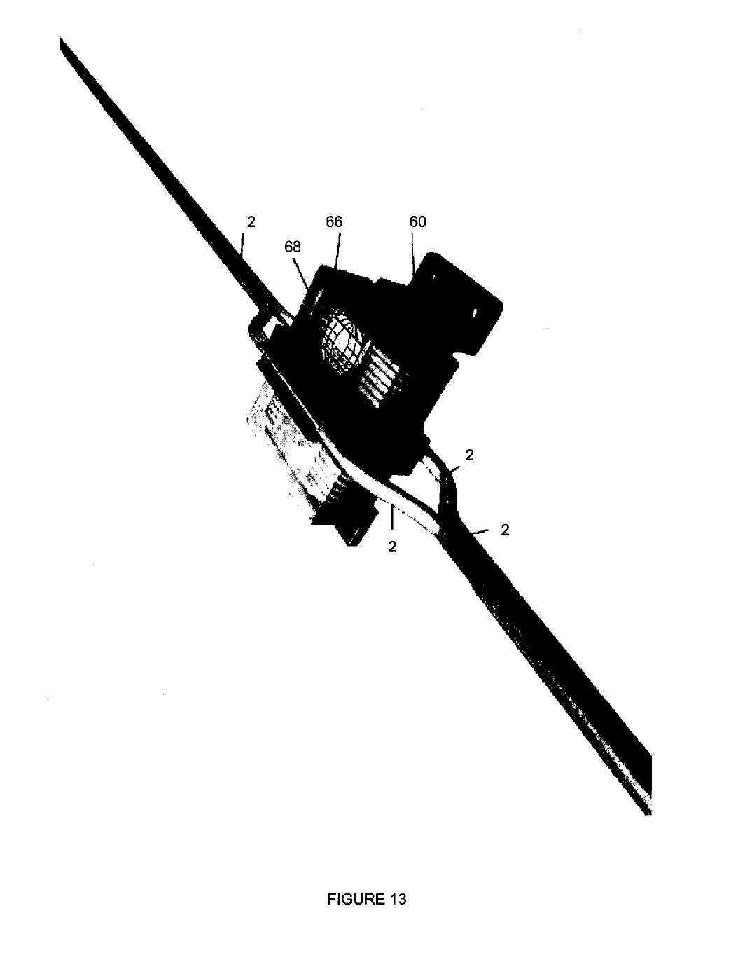

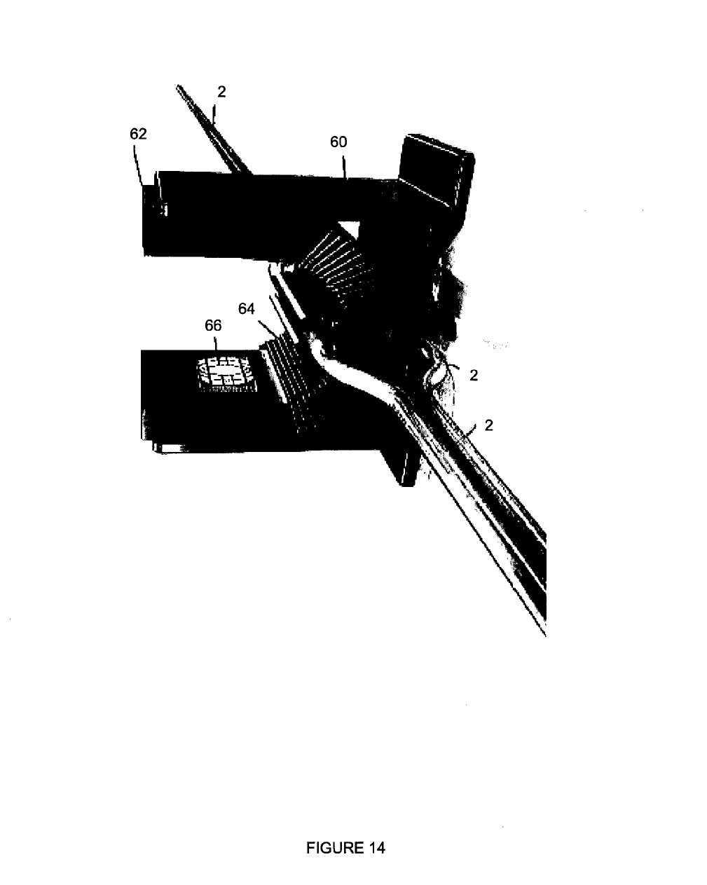

Some embodiments which use ferrite in the node 51 are shown in FIGS. 11 to 17. Referring to FIG. 11 and node 51 substantially as shown in FIGS. 8 and 9 is illustrated, having a ferrite core. The primary path 2 is formed to locate adjacent to the peripheral edges of the node. In FIG. 12 a further embodiment is shown having a former 60 which is adapted to locate in a separation of the conductors 2 of the primary conductive path. The former supports a ferrite core 62 under tuned circuit 64. The controller is referenced 66. FIG. 13 shows a further embodiment of the arrangement shown in FIG. 12, but in this embodiment the node is encased in a protective material 68. In FIG. 14 a further embodiment is shown in which a “horse shoe” or part torodial ferrite core 62 is shown.

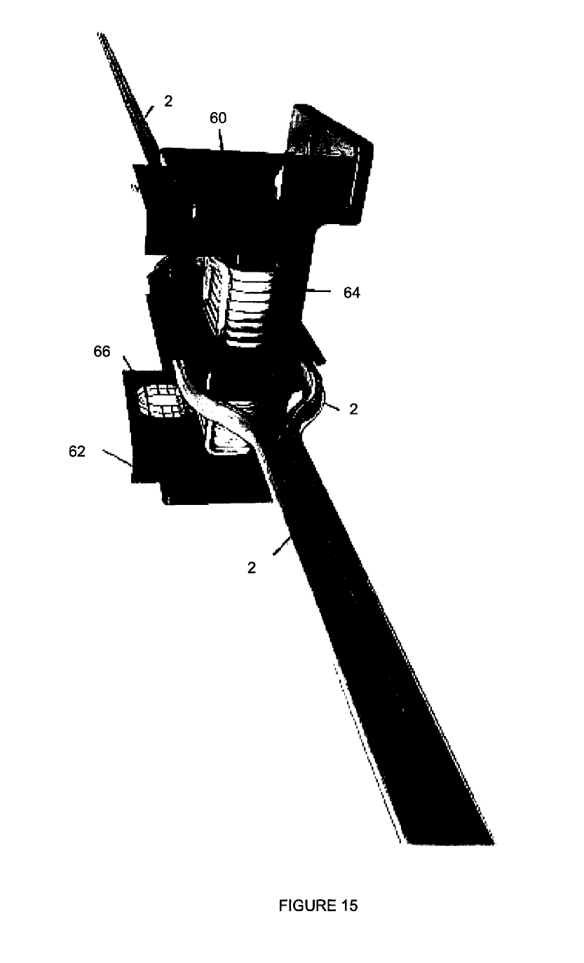

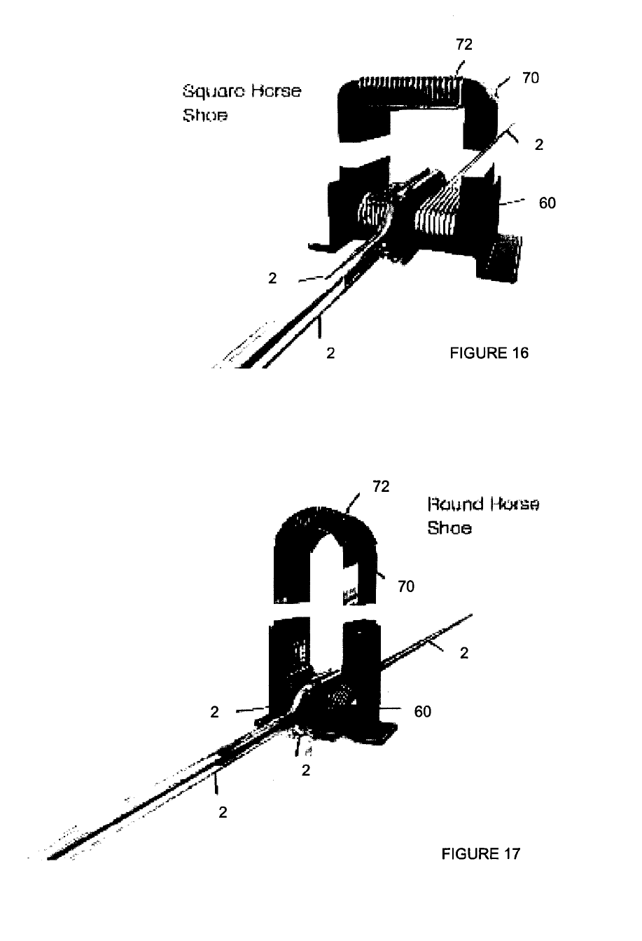

Yet a further embodiment of a node arrangement which includes a horseshoe or part-toroidal shaped core as shown in FIG. 15. The arrangements of FIGS. 14 and 15 are shown in FIGS. 17 and 16 respectively with an appropriate pick-up construction. Therefore in FIG. 16, an appropriate shaped horseshoe or part-toroidal ferrite core 70 is shown having a pick up coil 72 and a similar construction is shown for a pick up arrangement for FIG. 17.

The invention allows a node to completely control a pick-up. For example, the node 51 may include a memory with the processor 55 which includes an instruction set for control of the pick-up device. Thus the node may be programmed with a number of different required pick-up operational roles. A single communication instruction over the primary path (for example from a system controller associated with the power supply) may thus enable complex control of the individual pick-ups. This can reduce communication traffic through the system and thus make better use of available bandwidth. Similarly, nodes 51 may communicate with each other and thus eliminate unnecessary communication with over the path 2 with a system controller, again making better use of available bandwidth.

Therefore, it can be seen that the control of the resonant frequency of the node has a number of advantages, which include:
1. enabling highly efficient coupling between a path 2 and a pick up 3 so that maximum power transfer can occur when required and when power transfer is not required to the pick up the thermal load in the node can be effectively managed.
2. enabling direct control of a pick up from a node device, and therefore allowing the complexity and cost of the pick up to be reduced in situations where that is desirable, including making better use of available bandwidth.
3. accommodating for variations in the frequency of the RF current in the path 2 to ensure that a node can be tuned to ensure maximum available power transfer to a pick up device.
4. allowing improved overall system control so that in situations where there a plurality of pick up devices being supplied from a plurality of nodes, the power draw to unused or non-existent pick-ups can be minimised through detuning the relevant nodes so that maximum power is available at nodes which supply high demand pick-up devices.

As mentioned previously, this technology is equally applicable to a node extension device such as that disclosed in U.S. Pat. No. 7,675,197. Therefore, the node 51 may be physically connected to a power supply, or may be inductively coupled to a power supply.

Those skilled in the art to which the invention relates will appreciate that although the invention has been described with reference to an IPT powered road stud, this return communication system is applicable to any form of inductively powered apparatus. This may include material handling or people moving systems.

1. An inductive power transfer system (IPT) node comprising a communication circuit for receiving a communication signal from another component of an IPT system.

2. An IPT node as claimed in claim 1 wherein the communication circuit can transmit the communication signal by inductive coupling to a further component of an IPT system.

3. An IPT node as claimed in claim 1 wherein the communication circuit can transmit a return communication signal to the IPT system component.

4. An IPT node as claimed in claim 1 comprising a control circuit whereby the node controls power received from the IPT system in response to the communication signal.

5. An IPT node as claimed in claim 1 wherein the node controls the power supplied to an IPT pick-up in response to the communication signal.

6. An IPT node as claimed in claim 1 wherein the node transmits control signals to an IPT pick-up to thereby control the pick-up dependent on the communication signal.

7. An inductive power transfer (IPT) system including a primary conductive path, a plurality of nodes coupled to the primary conductive path, and at least one pick-up device coupled to each node and capable of receiving power inductively from the respective node, and wherein at least one node includes a communication circuit for receiving or transmitting a communication signal to or from the primary conductive path and/or the pick-up device.

8. An IPT system as claimed in claim 7 wherein the communication signal comprises an authentication signal.

9. An IPT system as claimed in claim 7 wherein the communication signal comprises a control signal.

10. An authentication method for an IPT system, the method including the steps of establishing communication between one component of the system and one or more other components of the system whereby the one or more components detects an authentication identifier of the one or more other components.

11. A method as claimed in claim 10 including the step of firstly transmitting an authentication request.

12. A method as claimed in claim 10 including processing the authentication identifier to determine whether the identifier is valid.

13-15. (canceled)

16. An IPT node as claimed in claim 2 comprising a control circuit whereby the node controls power received from the IPT system in response to the communication signal.

17. An IPT node as claimed in claim 3 comprising a control circuit whereby the node controls power received from the IPT system in response to the communication signal.

18. An IPT node as claimed in claim 2 wherein the node controls the power supplied to an IPT pick-up in response to the communication signal.

19. An IPT node as claimed in claim 3 wherein the node controls the power supplied to an IPT pick-up in response to the communication signal.

20. An IPT node as claimed in claim 4 wherein the node controls the power supplied to an IPT pick-up in response to the communication signal.

21. An IPT node as claimed in claim 2 wherein the node transmits control signals to an IPT pick-up to thereby control the pick-up dependent on the communication signal.

22. An IPT node as claimed in claim 3 wherein the node transmits control signals to an IPT pick-up to thereby control the pick-up dependent on the communication signal.

23. An IPT node as claimed in claim 4 wherein the node transmits control signals to an IPT pick-up to thereby control the pick-up dependent on the communication signal.
